(19) United States
(12) Patent Application Publication
(10) Pub. No.: US 2007/0043601 A1
(43) Pub. Date: Feb. 22, 2007

(54) Supply chain linkage management system

(76) Inventors: Takeshi Oguchi, Tokyo (JP); Yasuhito Fujita, Kawasaki-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/550,684

(22) PCT Filed: Mar. 25, 2004
(86) PCT No.: PCT/JP04/04173

§ 371 Date: Aug. 15, 2006

(30) Foreign Application Priority Data
Mar. 27, 2003 (JP) 2003-89097

(51) Int. Cl. G05B 19/418; G06F 15/02; G06F 9/46

(52) U.S. Cl. 705/8; 705/9

(57) ABSTRACT

The supply chain linkage management systems comprises; the transmission layer which transmits and receives the transaction information among companies etc. using the communications network; the business logic layer which manages the check of the contents of the message information transmitted and received from the transmission layer; the linkage management layer which performs tracking of demand information and supply information, inventory transition by linking the message information received from the business logic layer, which consists of; the linkage execution module to model the message information to four types of information, “demand information”, “supply information”, “inventory information”, and “production information”; the linkage logic module which processes the message information received from the business logic layer so that the data structure and linkage rule of a linkage execution module may be suited, and is delivered to the linkage execution module; the demand and supply tracking module which creates tracking information based on the linked information by the execution module. Therefore, the information required for the linkage management and the linkage method are separated from forms of companies, operating processes, sales channel, distribution channel, thus the linkage management can be performed free from these constraints.

### TECHNICAL FIELD

This invention is related to a method to link information on the movement of goods in a supply chain in order to manage a flow of goods from purchase of raw materials, production to sale until goods are delivered to consumers by companies and organizations (“supply chain”), to check if demand is balanced with supply at each stage in the supply chain, how a gap between demand and supply in the chain will impact to other stages.

### TECHNICAL BACKGROUND

As the management method of a supply chain, the flow of goods from purchase of raw materials, production and sale, to finished goods delivered to a consumer has been conventionally managed at each stage of the flow independently.

Various companies such as raw materials maker, components maker, assembly maker, wholesaler, retailer, have managed their supply chains by themselves, so that their operations can be carried out as planned. For example, the process from purchase of raw materials to production of components is managed as “components production stage”, the process from the assembly of components and to the production of products is separately managed as “assembly and production stage”; the process from the purchase of products to wholesale of products to retail stores is managed as “wholesale stage”, and the process from purchase of products from wholesalers to retail sales is managed as “retail sale stage”.

To manage a project such as shipbuilding, building construction, etc., the PERT method is known to manage a project so that the whole project is carried out in the most efficient way by probing specific events in the whole project and a number of activities in the whole project and by computing the fastest start time and the latest completion time of each activity.

The PERT method (“What is Systems Engineering” by Shigeru Watanabe and Masao Suga, Japan Broadcasting Corporation, Published on Feb. 20, 1970) firstly diagrams a certain project as the network where each work is combined, i.e., a network of an event and an activity. Then, the method enables us to manage the progress of a big project with tens of thousand events by inputting only two elements the number of an event before and after each activity and the duration required of the activity into a computer, and clarifying the correlation of each work.

Derivatives of the PERT/TIME method such as the PERT/COST method which takes in not only time management but also cost management of finishing the work most at the least cost within the given time, which is enhanced from PERT/TIME method, have been widely used.

The KANBAN system which conducts production and purchase of parts efficiently is also well known (“Supplier System” edited by Takahiro Fujimoto, Toshihiro Nishiguchi and Hideaki Itoh, Yuuhikaku Publishing Co., Ltd. Published in October, 1998). This system is a method where only required quantity is produced and only required quantity is purchased when required, and at the time when needed, and is a technique to make stock of parts and products least.

Moreover, the various management methods about production or distribution such as TOC (Theory of Constraints) MRP (Material Requirements Planning), Manufacturing Number management (“seiban”), and tracking service by a logistics company, are proposed and have been used.

However, looking at each management process from purchase of raw materials, production and sale, there are many uncertain elements or changing ones in such process. Thus, even if one manages each process by computer, it remains difficult to see the progress of a project as planned or to see always the updated status correctly.

It was very difficult to manage the whole process by linking to each process because one process is managed completely independently.

For example, when parts and materials are procured at a factory, by the order number, demand information (order information) is linked with supply information (arrival information), so that received quantity (unfilled quantity) and delivery time are managed.

However, this is a very simple method of comparing ordered contents with delivery results. In light of globalization in procurement, outsourcing of operations, unpredictable sharp fluctuations in demand, the need to manage not only actual demand information and supply information but also planned information and scheduled information (e.g. reserved or transportation-in-progress information) becomes urgent, but it is more difficult to manage this.

For example, to cope with severe fluctuations in demand, order information is given in many ways such as not only by actual order information but also forecast information, reserved order, confirmed order, delivery order etc

Therefore, while it is necessary to link all the demand information including actual and planned with all the supply information including planned and actual in order to manage a supply chain in theory, however, it has been difficult to make perfect linkage for the following reasons:
A) Each company has a unique way to operate business and as a result, how to use demand information such as order and supply information such as delivery is not the same. For instance, one company places an order with an order form, but another company buys parts to the extent that they actually consumes and does not use any order form.
B) Even within the same company, how to use demand information and supply information can be different depending upon its suppliers and the products.
C) How to use demand information and supply information is decided by various factors, such as forms of an enterprise, laws of a country, and lead time of transportation because many companies including components makers, trading companies, raw materials producers are located in many countries and in many regions.
D) It is common that a manufacturer uses plural logistics firms and a customer may decide its own logistics service provider. Therefore, supply information that logistics firms could obtain is different in terms of types and contents.
E) It is typical that a buyer, a party to receive an order, a logistics company uses different IT systems, thus, the contents of the information from their IT systems is different.

As you see now, there are many challenges to link demand information with supply information one-by-one using order number among inter-companies or inter-organizations.

Therefore, each company has managed a supply chain individually by linking order information based upon its own distribution channel and logistics route with supply information. In this case, the linkage is limited to partial information, for instance, the one between confirmed order information and tracking information by a logistics company, only, and it does not contain all the linkage of all the related information.

Furthermore, in a global supply chain, the request to see trading partners' status on production, purchasing and sale, such as a buyer's buyer and a supplier of a supplier, has been increasing.

For example, when a factory places an order to a trading company, the trading company places an order to a component maker and the component is delivered to the factory through the trading company from the component maker. The buyer of the factory contacted only the sales person at the trading company in charge of the component company, and checked delivery of goods.

Delay of delivery could be checked earlier and schedule could be managed in higher accuracy when a buyer in charge of a factory could know the order information to a part maker by a trading company or shipment information from a part maker to the trading company. However, since the numbers of individual linkages of the information turned into a huge number even if the factory is going to determine the linkage method individually among these companies, such information management was very difficult due to complication.

Many companies used to develop IT systems for core operations by themselves, however, companies are under pressure to cut the large cost and the time to develop such systems by themselves.

Therefore, in order to perform single database management, or real-time management, more companies recently implemented ERP (Enterprise Resource Planning) (“Guide to ERP” ERP Study Group, JMA Management Center Inc. Published on Nov. 1, 1997), or SCP (Supply Chain Planning) software packages which supports planning function of SCM (Supply Chain Management), however, which has not yet brought to the optimization of a global supply chain as a whole.

One of the reasons is cited as insufficient information share,—e.g. information share with a trading party (e.g. customer or supplier), or integration of the logistics information from a logistics company—with external parties through an execution system (e.g. ERP) across a whole supply chain.

ERP and SCP are the management tools on a batch process based on the management cycle of PDCA (Plan->Do->Check->Action) fundamentally, and these tools are inadequate in a management system based on the prediction of events to discover issues on real time basis and responding to them quickly on site by the linkage of demand information and supply information across a whole supply chain.

On the other hand, in the PERT method, the whole work is managed focusing on a critical path, namely, that the next work cannot be started if a certain work is not completed before. For example, when there is a work which uses only single part in large quantities, even if the factory to mass-produce the part does not complete production of the total quantities, the factory could ship some parts which production completed and ship the parts whose production completed after that one by one, the work of another producer who buys in and uses the part can be advanced smoothly. Thus, the delay in production of total quantities does not necessarily become a critical path.

Therefore, it does not bring optimal situations if we manage a supply chain by the PERT method.

Moreover, in the PERT method, if a change which is not expected in each work during the plan occurred, we would need to correct the plan each time and it is difficult and complicated to communicate with relevant parties about the correction or any change of a critical path.

Furthermore, in the PERT method, benefits could be obtained in that one project is completed as planned and as budgeted, it is impossible to apply the method to a management system which needs to manage continuously demand and supply of goods or a repetitive operation in daily commercial activities.

In production, in order to conduct the KANBAN system, it is necessary to fulfill the following conditions.

(1) Formation of a small lot

(2) Equalization of a production plan (it is required to produce two or more kinds of products at a uniform pace)

(3) Synchronization between processes (it is required to make supply speed of each process equal)

(4) Shortening of replacement time and conveyance time

If these conditions were to collapse, demand-and-supply balance would collapse and stock or out of stock would occur.

However, since it is necessary to process or assemble different kinds of products by various machines or the same machine in reality, it is very difficult to apply KANBAN system to all types of industries and businesses, and to balance demand and supply between machines (between processes).

In KANBAN system, as lot size is decided by replacement time and conveyance time, it is most important to eliminate wasted time as much as possible and to shorten replacement time and conveyance time as much as possible.

In this system, a small lot and multi-frequency transportation are needed. For example, a supplier of parts (to factory) is required to be located near to the factory in order to shorten lead time of transportation of a small lot, which may not be desirable to manage global procurement since this method works only in a limited area as a management method of demand and supply of components.

In addition to the above methods, various management methods regarding production and distribution, such as TOC system (“Inventory zero, Lead time reduction by-half, TOC project” Masaru Murakami, Tadayoshi Ishida, and Shinji Ikawa, Chukyo Publishing 2002), MRP system, Order number management, and tracking service by a logistic service provider are proposed and used, however, there has been no management method to control all the processes from supply of raw materials to delivery of goods to consumers across many organizations and trading partners.

In light of this background, this invention is made and it aims to provide linkage management system for detecting an issue in advance and resolving it by knowing a gap in demand and supply at each stage and possible business impact to other stages, and the status on inventory, in a supply chain where all the information on the movement of goods (e.g. demand information, supply information, production information, inventory information) is always managed exactly without any inconsistency in the business environments which every party (e.g. consumer, retail, wholesale, a factory, trading company, etc.) is concerned and which under any situations (e.g. quantity, delivery, location, change of route/addition or deletion of route).

### THE DISCLOSURE OF INVENTION

In order to attain the above-mentioned purpose, invention concerning a supply chain linkage management system given in the scope 1 of the claim consists of; i) the transmission layer which transmits and receives the transactional information (“message”) exchanged among companies and organizations using communication networks, such as the Internet; ii) the business logic layer which performs check of the contents of a message, and management of a message flow/workflow based on operating process rules' information, commercial channel information, physical distribution information, etc., against the message information transmitted and received at the transmission layer; iii) the linkage layer which performs the tracking of demand information and supply information, and the tracking of inventory transition by linking the message information received from the business logic layer.

The linkage management layer consists of; i) the linkage execution module to make message information into “demand information”, “supply information”, “inventory information”, and “production information” by a modeling; ii) the linkage logic module which processes the message information received from the business logic layer so that the data structure and the linkage rule of such message information can be adapted and which passes to the execution module; iii) demand and supply tracking module to generate tracking information based upon the linked information by the linkage execution module.

### BRIEF EXPLANATION OF THE DRAWINGS

FIG. 1 is the conceptual figure showing the composition of the linkage management system concerning this invention.

FIG. 2 is the conceptual figure showing the linkage method.

FIG. 3 is the figure explaining the view of an information model figure.

FIGS. 4 (A), (B), and (C) are the figures showing examples of demand information.

FIGS. 5 (A), (B), and (C) are the figures showing examples of supply information.

FIG. 6 is the figure showing an example of production information.

FIGS. 7 (A) and (B) are the diagrams showing examples of linking demand information with supply information.

FIG. 8 is the diagram showing an example of linking arranged supply information with arranged supply information.

FIG. 9 is the diagram showing an example of linking arranged supply information with multiple shipment supply information.

FIG. 10 is the diagram showing an example of linking shipment supply information with transportation supply information.

FIG. 11 is the diagram showing an example of linking demand information with demand information.

FIG. 12 is the diagram showing an example of linking supply information as unloading with inventory information.

FIG. 13 is the diagram showing an example of linking supply information as loading with inventory information.

FIG. 14 is the diagram showing an example of linking supply information as loading with inventory information.

FIG. 15 (A) is the diagram showing an example of linking production information on finished-products with inventory information. (B) is the diagram showing an example of linking production information on materials with inventory information.

FIG. 16 is the diagram showing an example of linking the first-tier demand-supply information with the second-tier demand-supply information.

FIG. 17 is the diagram showing an example of linking the upper-tier demand-supply information with production information on finished-products.

FIG. 18 is the diagram showing an example of linking production information on materials with down-tier demand-supply information.

FIG. 19 is the diagram showing an example of creating tracking information (example of linkage).

FIG. 20 is the figure showing the table based on FIG. 19.

### THE BEST WAY TO IMPLEMENT INVENTION

Hereafter, a reference case of the implementation of this invention is explained in detail based on drawings in the appendix. Although it has some technically favorable conditions to show a reference case of the implementation of this invention, the scope of the invention is not restricted to this case unless there are special remarks to limit the scope of this invention in the explanation below.

The definition of the terms used in this description is as follows:

Message information; transaction information exchanged among companies. E.g. order information, order response information, shipment information, inventory information.

Single-tier; management environment where there exists one set of a buyer and a seller only.

Multi-tier; management environment where there exist two or more sets of buyers and sellers.

Demander: those who demand the delivery of goods. Usually, buyer

Supplier: those who have responsibility in the delivery of goods in response to the demand from a buyer. Usually, seller.

Receiver; those who receive goods from a logistics company and keep the goods.

Shipper: those who perform shipment and hand goods to a logistics company.

Transporter: those who move goods to other points from a certain point by the means of transportation of railroad, track, vessel, airplane, and others.

[Implementation Case 1]

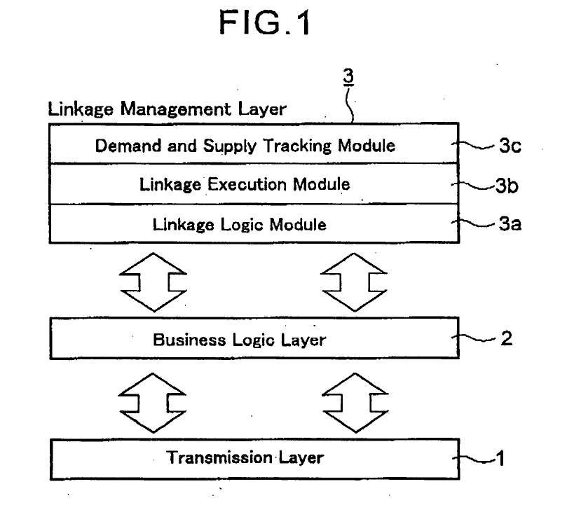

FIG. 1 is the conceptual figure showing the composition of the supply chain linkage management system, namely this invention, and shows 1) transmission layer; 2) business logic layer; 3) linkage management layer.

The linkage management layer 3) consists of 3a) linkage logic module; 3b) linkage execution module; 3c) supply-and-demand tracking module.

The transmission layer 1) is the layer which transmits the message information between the companies represented by a system like EDI (Electronic Data Interchange).

As each company has different back-end IT systems, functions including any-to-any translation of a file format, characters' code conversion, and data additions and processing, are required for the layer 1). The existing EDI system can be substituted for this functional layer.

The business logic layer 2) performs check of the contents of message information, and the administration of a message flow/workflow of the message information transmitted and received in the transmission layer 1) based on business processes and rules' information, sale channel information, and physical distribution information, specifically;

Check the business data in a message (e.g. order quantity, delivery time) based on business rules.

Modifications and processing of business data (e.g. to calculate requested shipment date from requested delivery date).

Message flow managements (e.g. administration of message senders/receivers, message forwarding)

Unfulfilled order management

As for the rule information on the business logic layer 2), it is set up for each trading partner since a business process/rule and sales channel, logistics differs in each trading partner.

The linkage management layer 3) carries out tracking of demand and supply, and inventory transition by the linkage of the message information received from the business logic layer 2).

The linkage information is passed to the linkage management layer 3) and the contents are changed whenever message information is created and changed.

In linkage logic module 3a), message information is processed to meet the data structure and the linkage rule of its upper-layer linkage execution module 3b) and necessary information is passed to the linkage execution module 3b).

Moreover, according to the rule set up in advance, setup, change and release of linkage are appropriately made upon the creation, change, and cancellation of a message.

In business logic layer 2), the contents of a message are checked, message information is affected due to the rejection of message information and the processing of data. In the linkage logic module 3a), data processing and set up of linkage are made to enable the linkage management, but message information itself is not affected.

In the linkage execution module 3b), message information is modeled to four types of information, i.e. “demand information”, “supply information”, “inventory information”, and “production information”, and the information received from the linkage logic module 3a) is controlled by the linkage management.

In supply-and-demand tracking module 3c), tracking information is created based on linked information by linkage execution module 3b).

Thus, one can detect where a gap in demand and supply in a supply chain arises and where the gap will affect in the supply chain.

The modeling method of the linkage execution module 3b), the core of the supply chain linkage management system, is explained below, together with the explanation on the linkage logic module 3a) to tie linkage model with message information and with the explanation on demand and supply tracking module 3c) to create tracking information.

In the linkage execution module 3b), the message information transmitted and received in the transmission layer 1 is modeled to four types of information, i.e. “demand information”, “supply information”, “inventory information”, and “production information”, to perform linkage management. Linked information is updated on real time whenever message information is transmitted and received in the transmission layer 1.

In addition, all of the linkage execution based on the linkage rule and the error processing at the time of linkage are performed by the linkage logic module 3a).

In the linkage execution module 3b), there is a function to make linkage based on the directions from the linkage logic module 3a), and it notifies the existing linkage information influenced when the linkage information is set up and updated as an event to the linkage logic module 3a). The processing method may be different because of the difference in the existing IT systems or business rules that each company has.

Four information models defined by the linkage execution module 3b) are shown below;

1) Demand information: Information which requires that an article should be delivered to a requested place (e.g. delivery forecast, reserved order, confirmed order, delivery order).

2) Supply information: Information showing a schedule or an actual result in delivering an article to a requested place (e.g. order response, shipment notice, receiving notice)

3) Inventory information: Information showing the number of stock of articles at a certain time at a storage place.

4) Production information: Information showing planned production or actual production of finished goods or showing demand of required materials in order to produce finished goods.

These four information models are linked by a reference number or a place information. By a reference number, the following cases are linked;

1) To link supply information to demand information

2) To link supply information to supply information

3) To link demand information to demand information

4) To link demand information to demand information in a different tier

5) To link demand information with production information

The linkage by a place information is as follows:

6) To link supply information with inventory information

7) To link supply information to supply information in a different tier

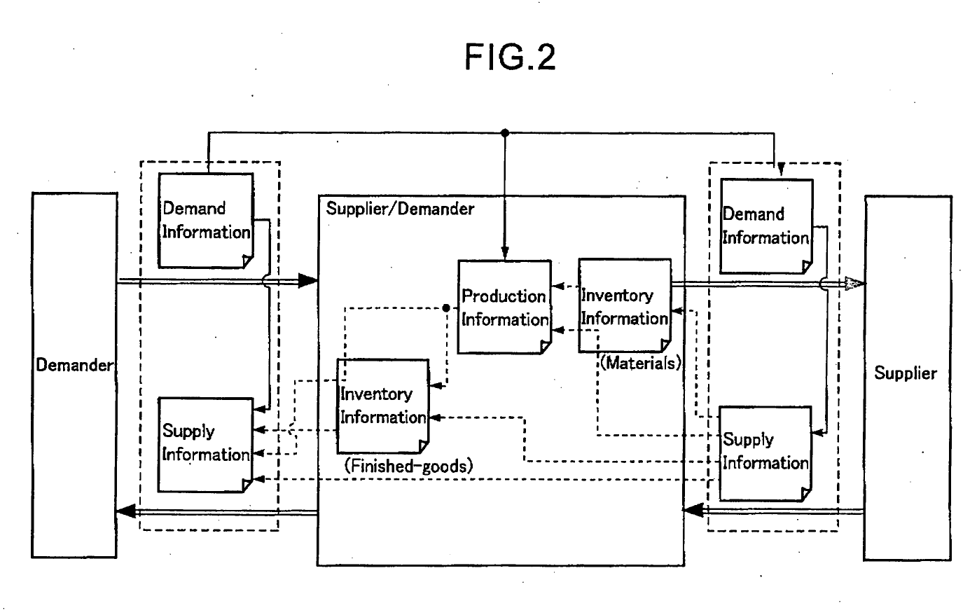

FIG. 2 is the conceptual figure showing the above linkage method. A solid line shows the linkage by a reference number and a doted line shows the linkage by a place information.

Here, although the case shows that there are two sets of buyers and suppliers, the same rule can be applied to link among trading partners in the upper stream and the down stream.

In addition, in make-to-order production, the linkage is managed by using production information+inventory information (work-in-process goods)+production information. Moreover, when production information needs more fine tracking, the linkage can be managed by combining two or more production information and inventory information.

Next, four information models (i.e. demand information model, supply information model, inventory information model, production information model) are explained.

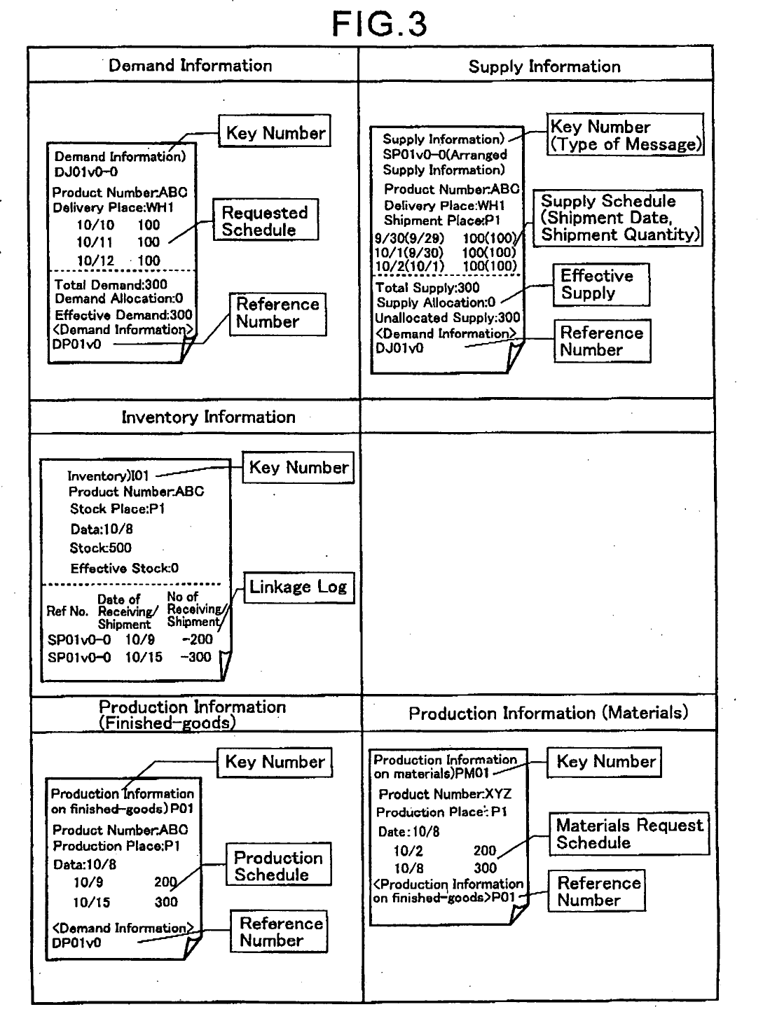

FIG. 3 is the diagram explaining the view of each information model's figure.

<1. Demand Information Model>

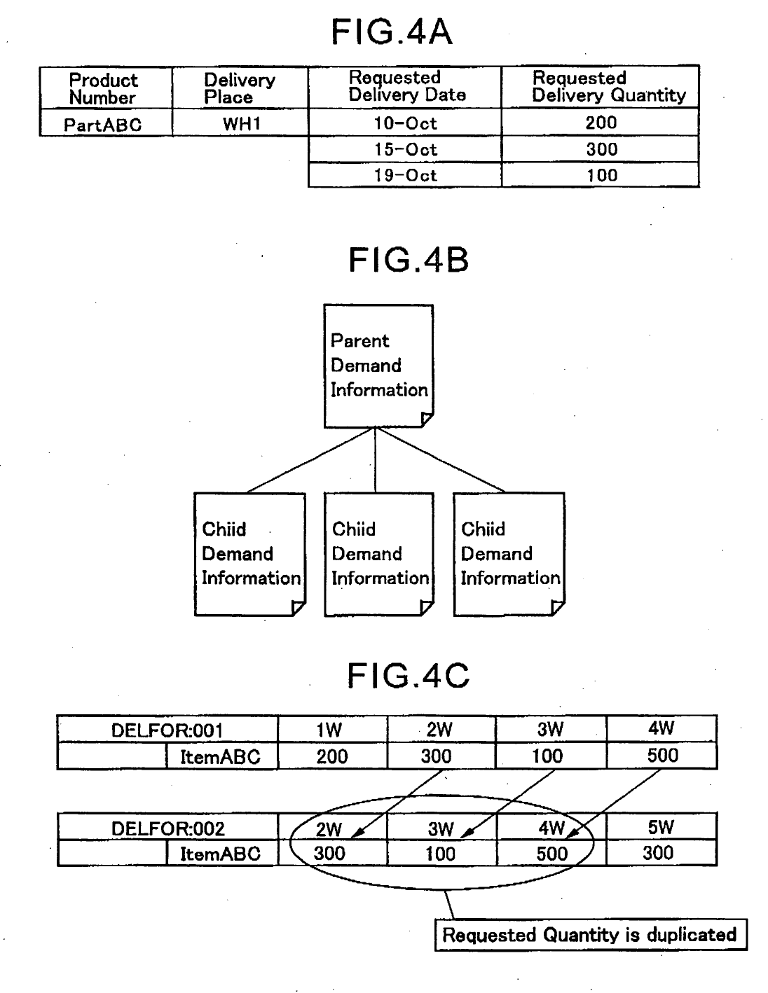

FIG. 4 is the figure showing examples of demand information, and FIG. 4 (A), FIG. 4 (B), and FIG. 4 (C) are diagrams to explain.

Here, “demand information” is the information as which a demander requests to deliver an article to a requested place with requested quantity by a requested date. The examples of the matter required of “demand information” are as follows; these can be changed by composition of a system.

One demand information can specify one article (Part ABC) to one requested place (WH1) with multiple requested delivery schedules (requested arrival date, requested arrival quantity) as shown in FIG. 4.

When demand information is linked to demand information, information to be linked is called “parent demand information” and information to link is called “child demand information”.

Several child demand information can be linked to one parent demand information. (refer to FIG. 4A).

The requested quantity of the demand information in the same linkage level must be mutually exclusive (refer to FIG. 4B).

When demand information is revised, all the requested quantity that the demand information requires needs to be included (refer to FIG. 4C).

<2. Supply Information Model>

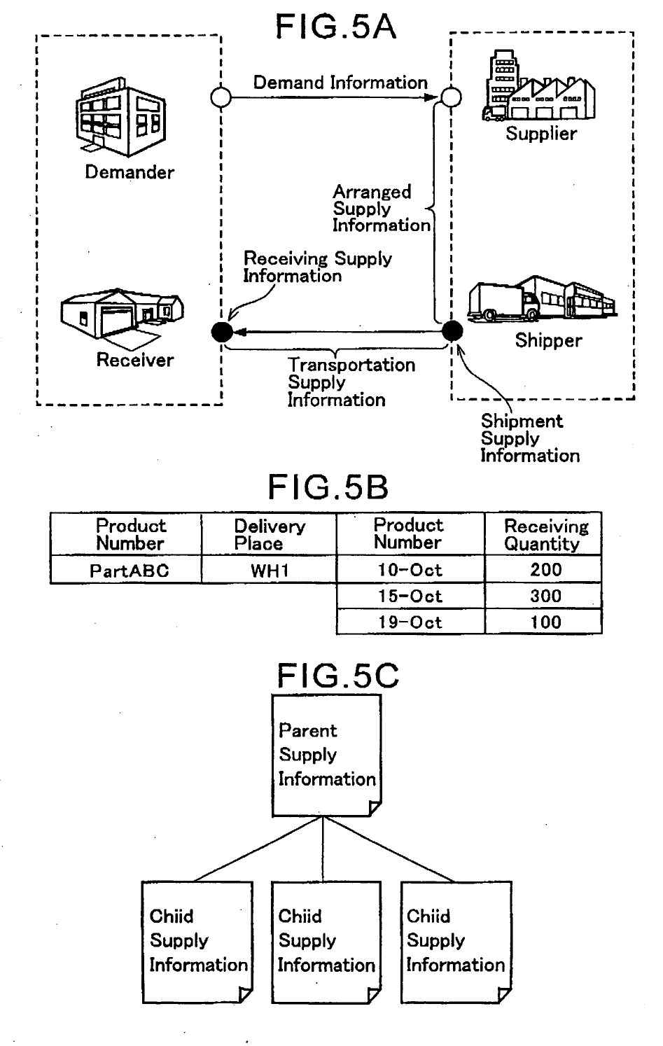

FIG. 5 is the figure showing the examples of supply information, and FIG. 5 (A) and FIG. 5 (B) are diagrams to explain.

“Supply information” is the information which notifies the supply status from a shipper to a receiver in delivering an article to a requested place at the request of a demander.

Supply information is divided into the “arranged supply information” showing a situation after receiving demand information until one arranges an article to be sent to a shipment place, the “shipment supply information” which notifies that the article is shipped from the shipper, the “transportation supply information” showing the transportation situation from a shipper to a receiver, and the “receiving supply information” showing that the receiver received the article (refer to FIG. 5). The examples of the matters required of “supply information” are as follows: These can be changed by composition of a system.

Supply information is published in the order of; arranged supply information→shipment supply information→transportation supply information→receiving supply information. Although shipment supply information and receiving supply information must be published, arranged supply information and transportation supply information can be omitted.

One supply information can specify two or more supply schedules to one article (Part ABC) and to one supply place (WH1) (refer to FIG. 5B).

When supply information is linked to supply information, the information to be linked is called parent supply information and the information to link with is child supply information.

Arranged supply information and transportation supply information can be linked by themselves, but, shipment supply information cannot be linked with receiving supply information.

Two or more child supply information can be linked to one parent supply information.

As for supply information, there is a case that an independent supply information exists without any linked demand information.

The supply quantity of the supply information in the same linkage level must be mutually exclusive.

When supply information is revised, all the numbers of supply that the supply information shows must be included.

<3. Inventory Information Model>

“Inventory information” is the information showing the quantity of articles at a certain time kept in a specific place. The examples of the matters required of “inventory information” are as follows: These can be changed by composition of a system.

One inventory information can specify one article and its stored quantity to one stored place.

A storage place can specify, not only a physical storage place but also a different logical storage place at the same place on a system in order to manage the specific stock for a demander. However, the number of stock in a different storage place must be mutually exclusive.

The inventory information is linked with supply information or production information through a parts number and a place information, whenever supply information and production information are updated, the contents of linkage is also updated.

When inventory information is linked with supply information, and if the delivery place is the same as the storage place, it is liked as incoming and if the shipment place is the same as the storage place, it is linked as outgoing. Thus if it is linked as outgoing, it is only linked with arranged supply information or shipment supply information but cannot be linked with transportation supply information or receiving supply information.

When inventory information is linked with production information, and if the production place on finished-goods is the same as the storage place, it is liked as incoming and if the production place on materials is the same as the storage place, it is linked as outgoing.

Inventory information is the information to keep articles, while demand information doesn't have stock keeping request. Thus, inventory information is not linked with demand information by a reference number.

Inventory information does not have any data field for revision because such data is not updated by the linkage logic module 3a).

<4. Production Information (Finished-Goods and Materials) Model>

“Production information” is the information which shows the production schedule of “finished-goods”, and the requested schedule of “materials” required for the production. Materials mean procured materials or the parts materials for make-to-order production.

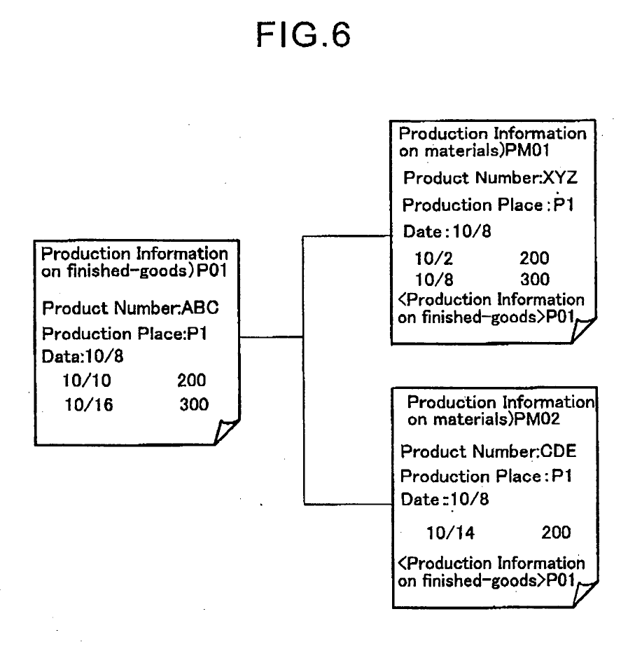

FIG. 6 is the figure showing an example of production information. The examples of the matters required of “production information” are as follows; these can change by composition of a system.

There are two kinds of production information, production information on finished-goods and production information on materials.

The linkage of production information on finished-goods and production information on materials is carried out by a production linkage number, or a production place. In addition, when production information on finished-goods or production information on materials is updated, all the production information influenced must be updated and be consistent.

the case where the linkage is carried out by a production linkage number, one or more production information on materials can be linked with one-finished goods (refer to FIG. 6)

the case where the linkage is carried out by a production place, multi finished-goods and multi materials can be linked by the same production place.

One information on finished-goods can have two or more schedules to one finished-goods and one production place (finished-goods schedule includes planned and actual schedule information).

One production information on materials can have two or more materials requested schedules to one production place (materials requested schedule includes planned and actual information).

As for production information, it is desirable that it is updated by MRP and SCP as appropriate, if unexpected problems (e.g. out of stock of materials) occurred, it would be desirable to re-make a plan and to update production information on finished-goods promptly.

production information is linked with demand information by a reference number, or with inventory information by a place information.

Next, here come the examples of the linkage method in the linkage management system, namely, this invention.

1. to link demand information with supply information

2. to link supply information with supply information

3. to link demand information with demand information

4. to link inventory information with supply information

5. to link inventory information with production information

6. to link demand information with demand information in a different tier

7. to link demand information with production information (finished goods)

8. production information (materials) and demand information are linked.

Eight patterns are explained.

<1. To Link Demand Information with Supply Information>

By specifying a semi key number of demand information (a demander, a supplier, demand information number, a message revision number, a linkage revision number) to the number linked by demand of supply information, the linkage is made.

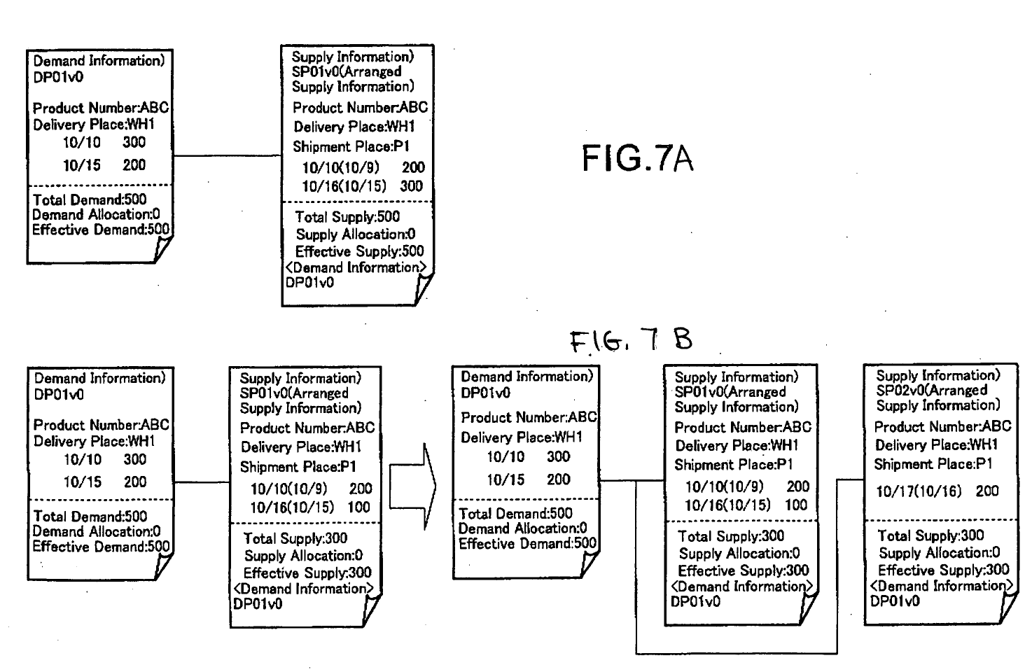

FIG. 7 (A) and FIG. 7 (B) show examples of linking demand information with supply information. FIG. 7(A) shows that one demand information (DP01v0) is liked with one supply information (SP01v0). FIG. 7 (B) shows that one demand information (DP01v0) is linked with one supply information (SP01v0), and is further linked with another supply information (SP02v0).

Only arranged supply information and shipment supply information are to be linked with demand information.

<2. Supply Information is Linked with Supply Information>

By specifying a semi key number of parent supply information (a demander, a supplier, a supply information number, a message revision number, a linkage revision number) to be the number linked by supply of child supply information, the linkage is made.

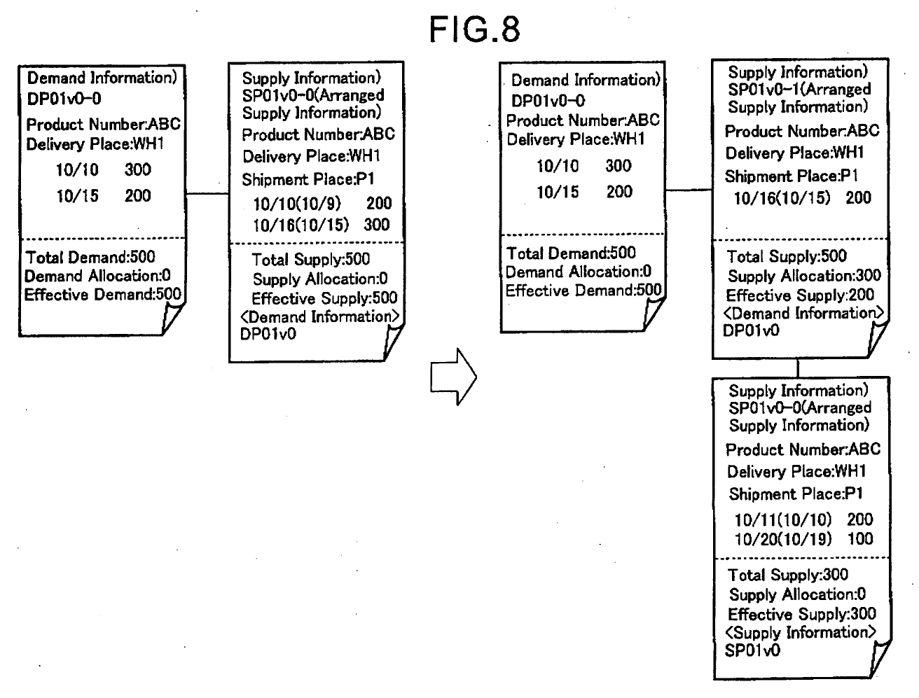

FIG. 8 shows a case where the arranged supply information is linked with the arranged supply, and that the linkage of the demand information (DP01v0-0) with the arranged supply information (SC01v0-0) is made to the linkage of the demand information (DP01v0-0) with two pieces of the arranged supply information (SC01v0-1) and (SC01v0-0).

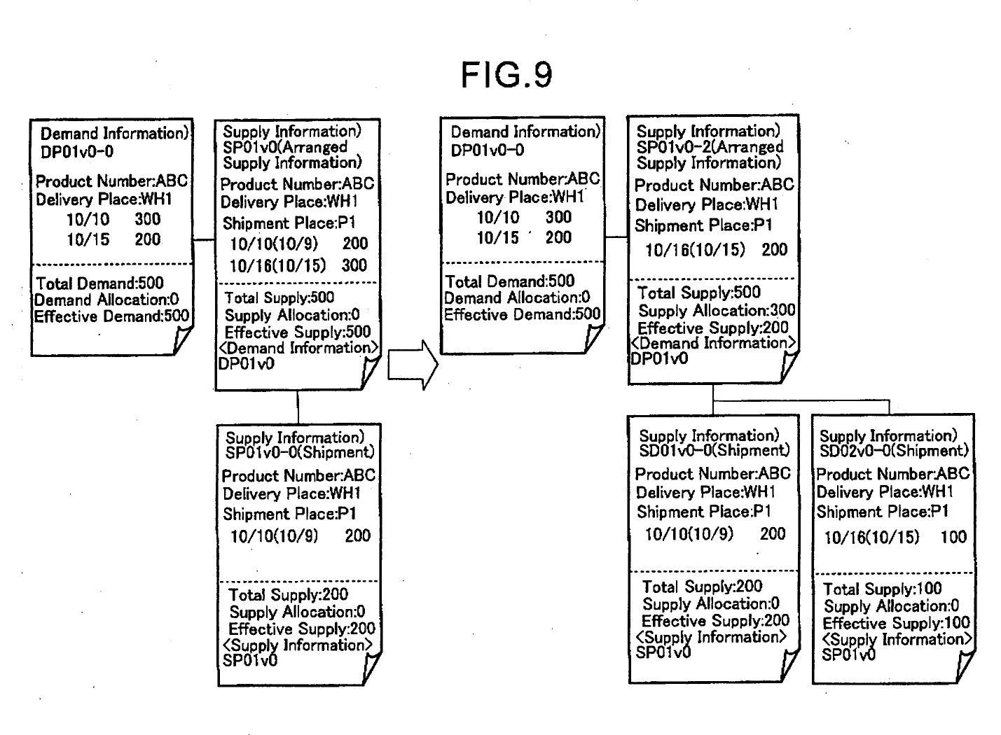

FIG. 9 is the example of linking arranged supply information with multi shipment information. It shows the demand information (DP01v0-0) is linked with the arranged supply information (SP01v0-1) and then arranged supply information (SP01v0-1) is further linked with the shipment supply information (SD01v0-0) and then is linked with the shipment supply information (SD02v0-0), the arranged supply information (SP01v0-1) is updated as the arranged supply information (SP01v0-2).

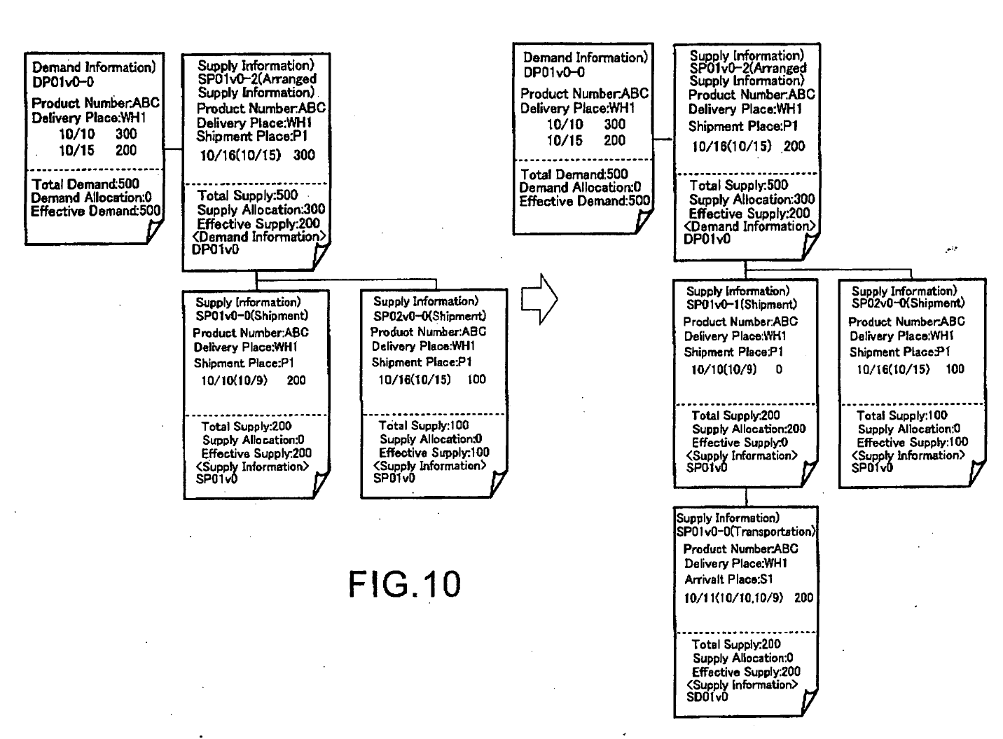

FIG. 10 is the example of linking shipment supply information with transportation supply information and shows that the demand information (DP01v0-0) is linked with the arranged supply information (SP01v0-2), and then the arranged supply information (SP01v0-2) is linked with the shipment supply information (SD01v0-0) and the shipment supply information (SD02v0-0). Moreover, the shipment supply information (SD01v0-0) is linked with the transport supply information (SP01v0-0), and the shipment supply information (SD01v0-0) is updated as the shipment supply information (SD01v0-1).

<3. Demand Information Linked to Demand Information>

By specifying the semi key number (a supplier, a supplier, a demand information number, a revision number) of parent demand information to the linked number by demand of child supply information, the linkage is made.

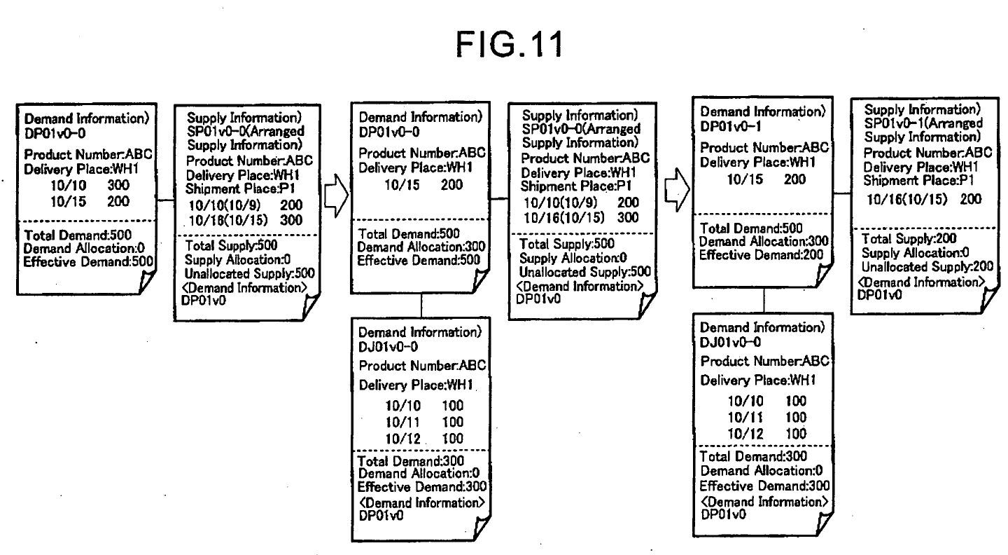

FIG. 11 is the example of linking demand information with demand information, and shows when the demand information (DP01v0-0) is linked with the arranged supply information (SP01v0-0), the child demand information (DJ01v0-0) is newly linked with the parent demand information (DP01v0-0), and the parent demand information (DP01v0-0) is updated to the parent demand information (DP01v0-1).

Furthermore, the arranged supply information (SP01v0-0) linked by the demand information (DP01v0-0) is updated to the arranged supply information (SP01v0-1).

<4. Inventory Information Linked to Supply Information>

When inventory information or supply information is created and updated by the linkage execution module 3b), a part number and a delivery place/shipment place and a storage place is checked, if each number is the same as each place, inventory information is automatically linked with supply information.

If the storage place of inventory information is the same as the shipment place of supply information, then it is linked as outgoing and if the delivery place of inventory information is the same as the storage place of supply information, it is linked as incoming. When inventory information and supply information are updated, the contents of linkage are also updated each time.

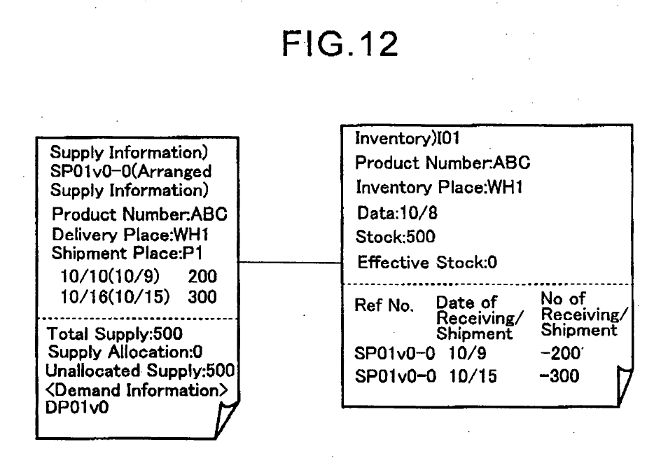

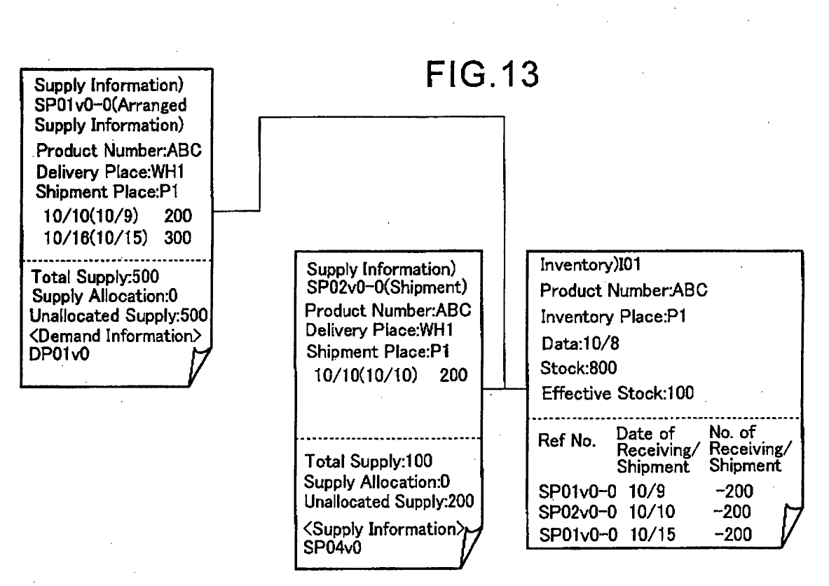

FIG. 12 is the example when supply information consists of one, the supply information (SP01v0-0) is linked with the inventory information (I01) as outgoing, and FIG. 13 is the example when supply information consists of more than one, the supply information (SP02v0-0) is linked with the inventory information (I01) as outgoing.

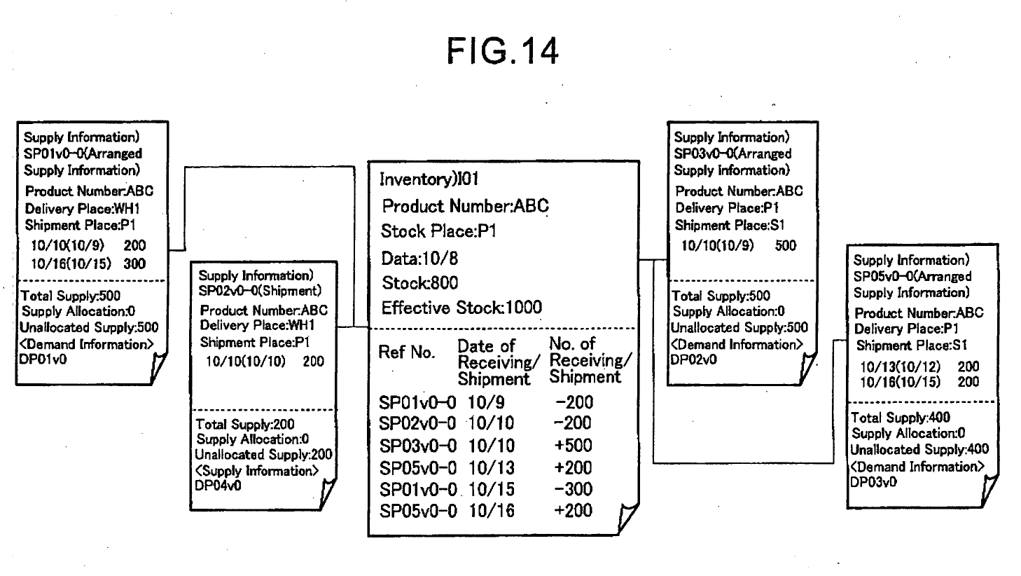

FIG. 14 is the example when the supply information is linked with inventory information as incoming, the inventory information already linked to the supply information as outgoing, is linked with several supply information as incoming.

<5. Inventory Information Linked to Production Information>

When inventory information or production information is created and updated by the linkage execution module 3b), a part number, a production place and a storage place are automatically checked; when each number is the same as each place, the inventory information is automatically linked with the production information.

As for the production information on finished-goods, it is linked as incoming; it is linked as outgoing for the production information on materials. When inventory information and production information are updated, the contents of linkage are also updated each time.

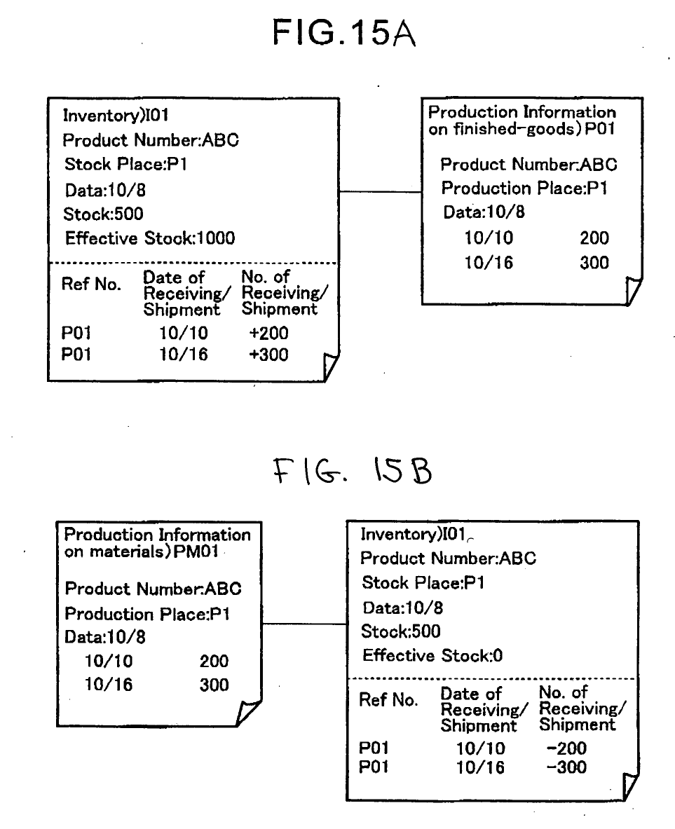

FIG. 15 (A) is the example of linking production information on finished goods (P01) with inventory information (I01) and the example of linking production information on materials (PM01) with inventory information (I01).

6. Demand and Supply Information Linked with Demand and Supply Information at Different Tiers:

By specifying a semi key number (a demander, a supplier, a demand information number, a revision number) of the most upper stream demand information in the first tier to the number linked by demand and supply of the most upper stream demand information at the second tier, the linkage is made.

When demand information does not exist in the first tier, the semi key number of the most upper stream supply information is specified.

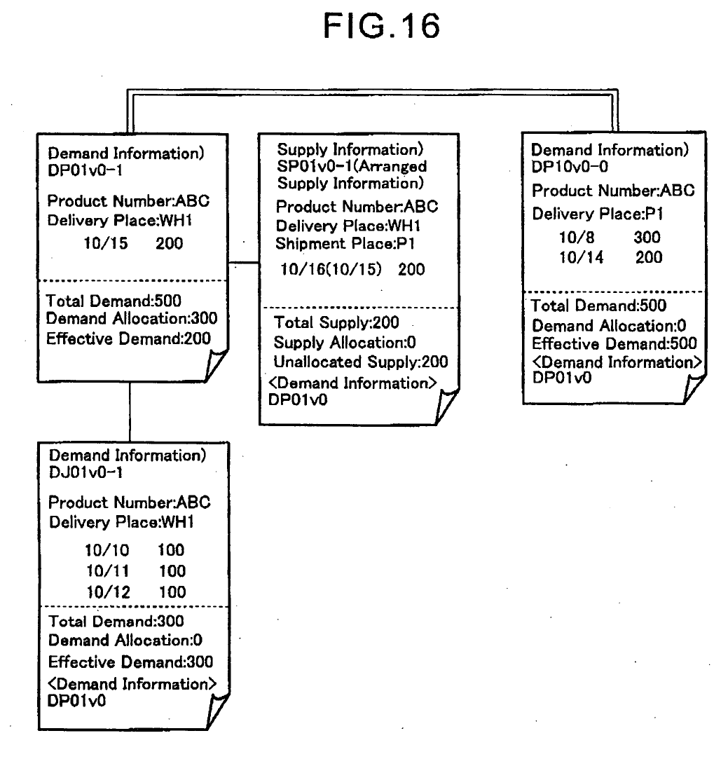

FIG. 16 is an example of linking demand and supply information at the first-tier with demand information at the second-tier.

7. Demand and Supply Information is Linked with Production Information on Finished Goods:

By specifying a semi key number (a demander, a supplier, a demand information number, a revision number) of the demand information at the most upper stream to be the number linked by demand and supply of production information on finished goods, the linkage is made.

When demand information does not exist in the first-tier, the key number of the supply information at the most upper stream is specified.

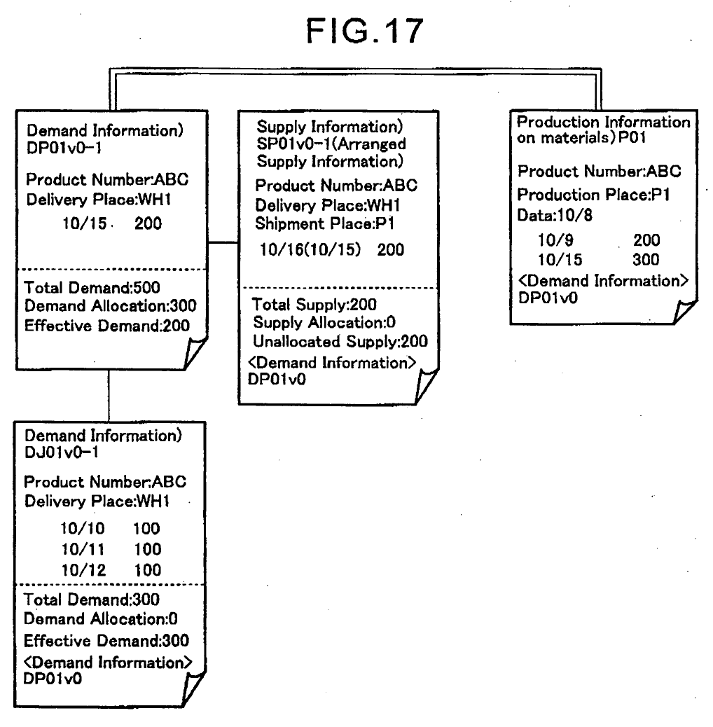

FIG. 17 is an example of linking demand and supply information at an upper tier with product information on finished goods.

8. Production Information on Materials is Linked with Supply-and-Demand Information:

By specifying a key number (a demander, a supplier, demand information, information time) of production information on materials to be the number linked by demand and supply of demand information in the most upper stream at a lower-tier, the linkage is made.

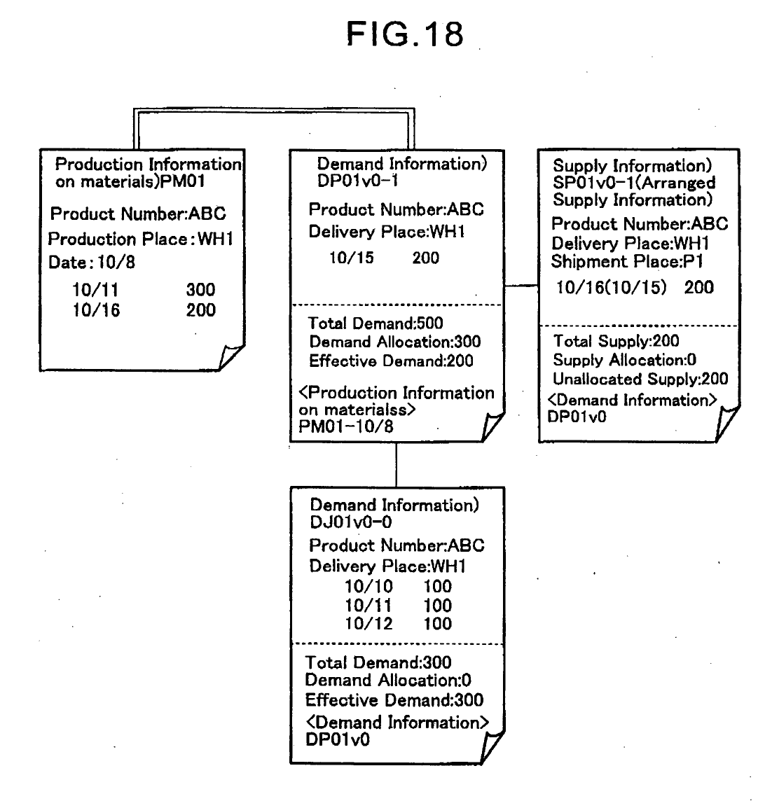

FIG. 18 is an example of linking production information on materials with demand and supply information at a lower-tier.

Next, how to update information in the supply chain linkage management system is explained with the following four examples: 1) update of supply information; 2) update of demand information; 3) update of inventory information; 4) update on production information.

1. Update on Supply Information:

The total number of supply and the number of effective supply are automatically updated according to the contents of the update.

a) When Supply Information Exists Independently:

When the total number of supply is changed, it must be more than the number supply allocation (0).

b) Supply Information is Linked with Parent Supply Information.:

When the total number of supplies is changed, it must be more than the number of supply allocation, and the number of supply allocation of parent supply information and the number of effective supply of parent supply information are re-calculated.

The change request event on parent supply information is notified to the linkage logic module 3a). The linkage logic module 3a) updates the supply schedule of parent supply information so that the number of effective supply will be met.

c) Supply Information is Linked with Child Supply Information:

When the total number of supply is changed, it must be more than the number of supply allocation. It is necessary to change first the total number of supply of child supply information if we need to change the number below the number of supply allocation. These are performed by the linkage logic module 3a).

d) Supply Information is Linked with Inventory Information:

When the total number of supplies is changed, it must be more than the number of supply allocation, and the number of effective stock of inventory information is re-calculated. When a place information (shipment place, delivery place) is changed, the linkage is canceled, and the supply information is linked with other inventory information as needed.

e) Supply Information is Linked with Demand:

When the total number of supply is changed, it must be more than the number of supply allocation.

f) Supply Information is Lined with Demand Information at a Different Tier:

When the total number of supplies is changed, it must be more than the number of supply allocation.

2. Update on Demand Information:

The total number of demand and the number of effective demand are automatically updated according to the contents of update.

a) When Demand Information Exists Independently

When the total number of supply is changed, it must be more than the number of demand allocation (0).

b) Demand Information is Linked with Parent Demand Information:

When the total number of demand is changed, it must be more than the number of demand allocation, and the number of demand allocation of parent demand information and the number of effective demand of parent demand information are re-calculated. The change request event on parent demand information is notified to the linkage logic module 3a).

The linkage logic module 3a) changes the demand schedule of parent demand information so that the number of effective demand will be met.

c) Demand Information is Linked with Child Demand Information:

When the total number of demand is changed, it must be more than the number of supply allocation. It is necessary to change first the total number of demand of child demand information if we need to change the number below the number of demand allocation. These are performed by the linkage logic module 3a).

d) Demand Information is Linked with Supply Information:

When the total number of demand is changed, it must be more than the number of demand allocation. The change request event on supply information is notified to the linkage logic module 3a), and the linkage logic module 3a) performs the checking of the update so that the number of effective demand of demand information will be met. In addition, an updating plan follows the rules decided in advance.

e) Demand Information is Linked with Production Information:

When the total number of demand is changed, it must be more than the number of demand allocation.

f) Demand Information is Linked with Demand Information in a Different Tier:

When the total number of demand is changed, it must be more than the number of demand allocation.

3. Update on Inventory Information:

a) Inventory Information is Linked with Supply Information:

The number of effective stock is updated to all the supply information linked (incoming side and outgoing side). When the number of effective stock becomes zero or less, it is notified to the linkage logic module 3a).

b) Inventory Information is Linked with Production Information:

The number of effective stock is updated to all the supply information linked (incoming side and outgoing side). When the number of effective stock becomes zero or less, it is notified to the linkage logic module 3a).

4. Update on Production Information:

a) Production Information is Linked with Inventory Information:

The number of effective stock of inventory information is re-calculated. When a production place is changed, the linkage is cancelled and is linked with other inventory information as needed.

Next, the linkage logic module 3a) of the linkage management layer 3) is explained. (refer to FIG. 1) According to the rule set up in advance, based on the information received from the business logic layer 2), an execution request is made to the linkage execution module 3b), and linkage is performed in the linkage logic module 3a). Specifically,

1. Processing and Addition of Information:

When the information received from the business logic layer 2) does not suit the required data format in the linkage execution module 3b), the processing and addition of such information is made according to the rule decided in advance. (e.g. linkage of delivery forecast, delivery time request of a blanket order)

2. Creation and Modification of a Reference Number:

When the reference number of a linked information is not specified in the information delivered from the business logic layer 2), a reference number is created, or a reference number is modified if needed.

The creation method and the modification method are determined in advance based on a business process.

3. Specification of Type of Supply Information:

According to the rule decided in advance, the type of supply information is specified for the supply information received from the business logic layer 2).

4. Correction and Update of Demand Schedule and Supply Schedule:

The demand schedule (delivery date request, requested quantity) and supply schedule (delivery date, requested quantity) received from the business logic layer 2) may be based upon total number of demand and the total number of supply.

In the linkage execution module 3b), since they are based on the number of effective demand and the number of effective supply, a schedule may need to be corrected if needed. The correction method is determined in advance according to a business rule.

5. Issue of the Linkage Execution Request to the Linkage Execution Module:

Information required for the linkage is delivered to the linkage execution module 3b), and the linkage execution command is issued.

6. Receiving and Event Processing of an Event Issued by the Linkage Execution Module:

As a result of performing linkage execution, when an event is received from the linkage execution module 3b), the event is processed according to the rule decided in advance.

Demand and supply tracking module 3c) in the linkage management layer 3) is explained based on FIGS. 1, 19, and 20.

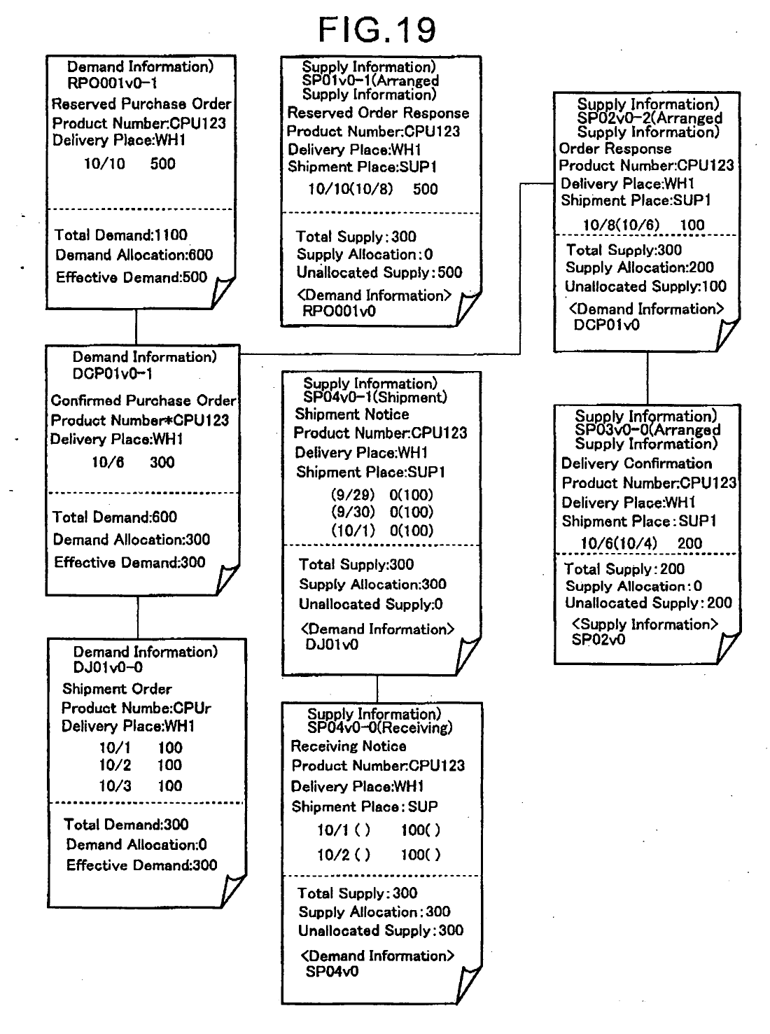

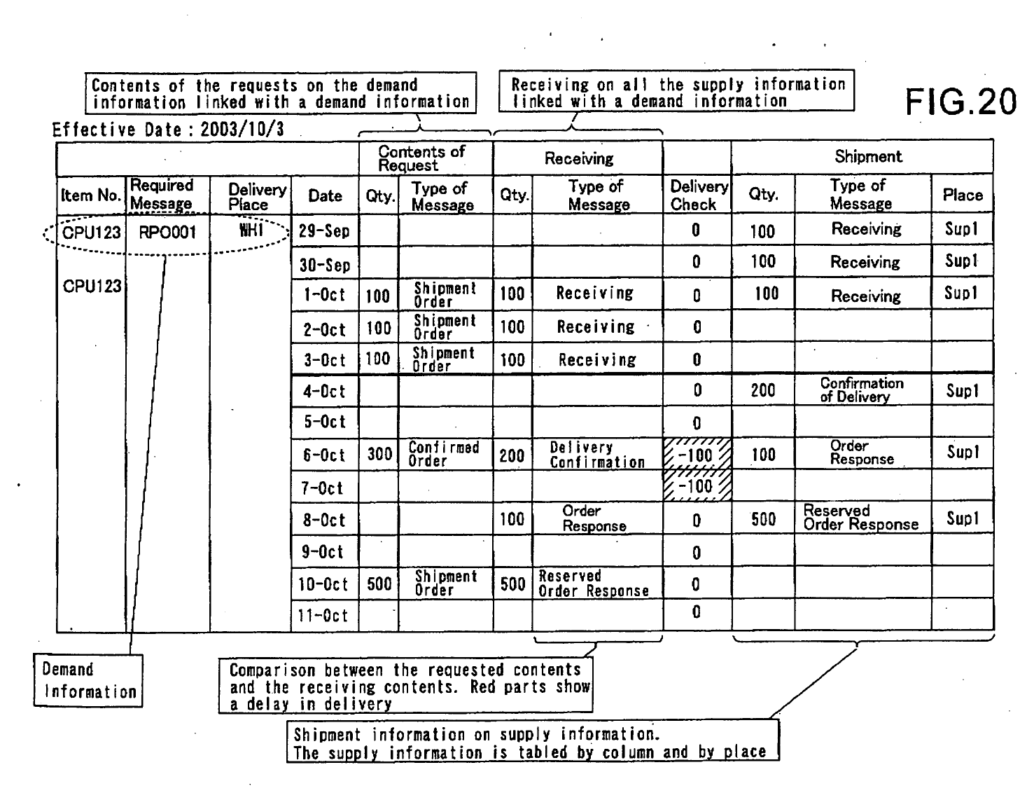

FIG. 19 is an example of the creation of tracking information (e.g. example of linkage), and FIG. 20 is a table based on FIG. 19.

Supply-and-demand tracking module 3c) offers the function to check whether supply is performed as requested based on the information linked by the linkage execution module 3b).

In this function, in a whole supply chain across multi-tiers, comparisons are made among requested date, requested quantity, delivery date, delivered quantity so that the date, the duration and the affected quantity (delayed or early) when delivery delay (or early delivery) occurs are viewed on real time from shipment place to delivery place. Moreover, inventory transition with all inventory points can also visualized together.

Hereafter, the example of the demand and supply tracking method of supply-and-demand tracking module 3c) is explained.

1) Creation of a Tracking Table:

The number of demand and the number of supply in each place (requested place, route, and delivery place) are tabled in the order of dates based on the information linked by the linkage execution module 3b). Specifically,

A demand information is selected. (note: no necessary for demand information to be in the most upstream.)

the contents (e.g. delivery date, requested quantity) of the selected demand information and all the demand information linked with the selected demand information in a lower stream are tabled in the order of dates in the column of the requested demand. (note: the information that the number of effective demand is zero, does not have any requested demand, no calculation is made as a result.)

the requested contents (e.g. delivery date, delivered quantity) of the selected demand information and of all the demand information linked with the selected demand information in a lower stream are tabled in the order of dates. The column is divided by a place information of supply information. (note: the information that the number of effective demand is zero, does not have any requested demand, no calculation is made as a result.)

the contents of supply (e.g. delivery date, supply quantity) of the selected demand information and of all the supply information linked with the selected demand information in a lower stream are tabled in the order of dates. At this time, a column is divided according to a place information on supply information. The contents of supply at the delivery place are tabled in the right of the column of the requested demand as delivery column, and by each supply place, the contents of supply from shipment to delivery of goods are tabled to the direction of the left from the right toward the delivery column.

In the case of supply information linked with inventory information, the number of stock is tabled to the place column by dates in the right-hand side of supply information for shipment, and is tabled by dates in the left-hand side of supply information for delivery. The number of stock by dates is calculated from the linkage log of inventory information.

In the case of inventory information linked with production information, the contents of production (e.g. completion day, completion quantity, materials requested date, requested materials quantity) are tabled by date in the right-hand side of inventory information for production information on finished goods and in the left-hand side of inventory information for production information on materials.

In the case of demand and supply information linked with production information on finished-goods, the contents of production is tabled in the right-hand side to the place column of the same demand and supply information as the production place. In the case of demand and supply information linked with production information on materials, the requested demand is tabled in the left-hand side to the place column of the same demand and supply information as the product place.

In the case of demand and supply information liked with demand and supply information in a different tier, the shipment information on the first-tier supply information is put left and the requested information on the second-tier demand and supply information is put right by dates, in order to see arranged information to the first-tier demand and supply information.

2) The Comparison Method:

In order to visualize whether the delivery of goods may be delayed (or early) from when to when, the accumulated number of [the number of supply−the number of demand] is calculated in the same column which has the place information in a tracking table.

When checking the delivery of goods for demand information, the accumulated number of [the number of supply−the number of demand] is calculated at a delivery place. When the requested shipment date and requested shipment quantity at a shipment place are also known, it is also possible to calculate the accumulated number of [the number of shipment−the number of requested quantity], and to check the supply situation at a supply place.

When comparing demand and supply information with production information on finished-goods such as make-to-order production, the accumulated number of [the number of finished goods−the number of shipment] is calculated at a shipment place (a production place). When comparing production information on materials with demand and supply information, the accumulated number of [the number of supply−the number of demand] is calculated at a production place (a delivery place).

In order to check arrangements situation in a different tier, when comparing demand and supply information with demand and supply information in a different tier, the accumulated number of [the number of supply for the second-tier demand information−the number of demand for the first-tier information] is calculated at the time of direct delivery: for non-direct delivery, the accumulated number of [the number of supply−the number of demand] for each and the accumulated number of [the number of supply for the second-tier supply information−the number of shipment for the first-tier supply information] for each is calculated. By doing this, it can be checked whether an article can be shipped from a shipment place as planned.

Inventory transition in each storage place can be checked by the number of stock in a tracking table according to the date.

### APPLICATION OF THIS INVENTION TO INDUSTRY

According to the invention given in the scope 1 of the claim, by modeling the information required for linkage tracking, we can perform the linkage management with the modeled information only and the information required for the linkage management and the linkage method can be separated irrespective of a company and an organization, an operating process, a sale channel and a physical distribution flow, etc.

Therefore, the linkage management of the information from the order to the delivery of good including both planned and actual ones across two or more organizations and companies can be realized as well as the real time tracking by the linkage management and it will become unnecessary for each company to develop proprietary systems individually. Consequently, cost to develop such a proprietary system will be reduced and time to develop it will be shortened.

Based on this supply chain linkage management system, a supply chain risk management system can be realized, including weighted risk evaluation function to any detected problems, What-if simulation function, and performance analysis function, in order to manage the risks arising from imbalance in demand and supply in a global supply chain.

The scope of the claim:

1. Supply chain linkage management system consists of; the transmission layer which transmits and receives transaction information exchanged among companies and organizations using the communications networks, such as the Internet; the business logic layer which performs check of the contents of a message information, and the management of a message flow/workflow based on operating process rule information, sales channel information, physical distribution information, etc., which are transmitted and received from the transmission layer; the linkage management layer which performs the tracking (tracing) of demand information and supply information, and of inventory transition, by linking the message information received from the business logic layer. The linkage management layer consists of; the linkage execution module to model the message information into “demand information”, “supply information”, “inventory information”, and “production information”; the linkage logic module which processes the message information received from the business logic layer so that the data structure and the linkage rule of the linkage execution module may be suited and which passes to the linkage execution module; the demand and supply tracking module which creates tracking information based on linked information created by the linkage execution module.
